(19) United States
(12) Patent Application Publication
(10) Pub. No.: US 2020/0326732 A1
(43) Pub. Date: Oct. 15, 2020

(54) VEHICLE FUEL LEVEL DISPLAY SYSTEMS AND METHODS

(71) Applicant: Ford Global Technologies, LLC, Dearborn, MI (US)

(72) Inventors: Mahmoud Yousef Ghannam, Canton, MI (US); David Jeffeory Berels, Plymouth, MI (US)

(21) Appl. No.: 16/381,899

(22) Filed: Apr. 11, 2019

(51) Int. Cl. G05D 9/12; B60S 5/02; B60Q 5/00; B60Q 1/50; B60R 11/04; G07C 5/08; G06Q 30/02

(52) U.S. Cl. CPC G05D 9/12; B60S 5/02; B60Q 5/005; B60K 2015/03217; B60R 11/04; G07C 5/0825; G06Q 30/0206; B60Q 1/50

(57) ABSTRACT

Methods and devices are disclosed for determining and displaying the current fuel level to a vehicle operation while the vehicle ignition is turned off. An example vehicle includes a fuel tank including a fuel sensor, one or more external vehicle displays, and a processor. The processor is configured to determine a current fuel level of the fuel tank, determine a cost to fill the fuel tank, and display the current fuel level and the cost to fill the fuel tank on the one or more external vehicle displays, while a vehicle ignition is turned off.

### TECHNICAL FIELD

The present disclosure generally relates to vehicle fuel tanks information display and, more specifically, to external display of the fuel level and a cost required to fill the fuel tank.

### BACKGROUND

Oftentimes, vehicles include a fuel tank having one or more fuel gauges, which collect information about the fuel level or amount of gas left in the tank. This information is then displayed to the vehicle operator during operation of the vehicle, so as to indicate to the operator how much fuel is left so he or she can determine whether to go to a gas station to fill up the tank.

Some fuel gauges and displays only provide a rough calculation of the fuel level, such as empty, ¼, ½, ¾, and full. These vehicles may not indicate to the operator the amount in gallons, but may only provide an amount of fuel left relative to the size of the tank.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for displaying to an operator the level of fuel in the fuel tank, the number of gallons needed to fill the fuel tank, and/or a cost to fill the fuel tank. An example disclosed vehicle includes a fuel tank including a fuel sensor. The vehicle also includes one or more external vehicle displays. The vehicle further includes a processor configured to determine a current fuel level of the fuel tank. The processor is also configured to determine a cost to fill the fuel tank. And the processor is further configured to display the current fuel level and the cost to fill the fuel tank on the one or more external vehicle displays, while a vehicle ignition is turned off.

In some examples, the processor is further configured to display the current fuel level and the cost to full the fuel tank on the one or more external displays responsive to determining that (i) the vehicle ignition is turned off and (ii) that a fuel filler of the fuel tank is open. In some examples, the processor may also be configured to receive a target fuel tank input amount, wherein combination of (i) a fuel amount corresponding to the target fuel tank input amount and (ii) a starting fuel level is less than a full fuel level; determine a target end fuel level based on the target fuel tank input amount; and automatically stop an in-progress fueling operation responsive to determining that the current fuel level matches the target end fuel level. The target fuel tank input amount may comprise one or more of a target amount of money, a target quantity of fuel to add, and the target end fuel level. Further, the processor may be configured to (i) flash one or more vehicle lights or (ii) emit a sound using a vehicle horn responsive to determining that the current fuel level matches the target end fuel level.

In some examples, the vehicle may be configured for vehicle to infrastructure (V2I) communication. The vehicle may determine the current fuel level, and/or a cost to fill the fuel tank based on vehicle to infrastructure communication. In some examples, the vehicle may include one or more external facing cameras, and the vehicle may determine the current fuel level and/or a cost to fill the fuel tank based on images captured by the one or more cameras.

In some examples, the vehicle may determine the cost to fill the tank based on a geographic location of the vehicle. Further, the vehicle may be configured for communication with a remote computing device, which may provide information related to the vehicle location, price of gas, and more, and wherein the vehicle may be configured to transmit the fuel level and/or cost to fill the fuel tank to the remote computing device.

An example disclosed method includes determining a current fuel level of a fuel tank of a vehicle, the fuel tank including a fuel sensor. The method also includes determining a cost to fill the fuel tank. The method further includes displaying the current fuel level and the cost to fill the fuel tank on one or more external vehicle displays, while a vehicle ignition of the vehicle is turned off.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example vehicle in accordance with the teachings herein.

FIG. 2 illustrates a vehicle at a gas station in accordance with the teachings herein.

FIG. 3 is a block diagram of electronic components of the vehicle of FIG. 1.

FIG. 4 is a flowchart illustrating various methods for displaying the fuel level and cost to fill the fuel tank in accordance with the teachings herein.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

As noted above, some vehicle fuel gauges and displays include an indicator that shows when the fuel tank is empty, ¼, ½, ¾, and full. These displays do not, however, indicate the number of gallons left or number of gallons needed to fill the tank. The vehicle operator is thus left to guess at how much he or she may be required to add to fill the tank. In addition, for vehicle operators who wish to pay with cash, or for gas stations that do not include credit card readers at the pump, the operator may be required to guess how much gas is needed, and/or must leave a credit card with an attendant while pumping gas. Some vehicles also display the fuel level only when the vehicle ignition is on, thereby preventing the vehicle operator from seeing the fuel level display change as fuel is added to the fuel tank. This makes it difficult for the driver to fill the tank to a desired level that is less than a full tank.

Vehicle operators thus may benefit from knowing how many gallons are required to fill the tank, knowing a current level of fuel as the tank is being filled, and viewing a display of this information while the vehicle ignition is turned off and the fueling is in progress. This may provide the operator with more confidence that the tank is full or that he or she can stop filling at a particular level, and to enable operators to accurately prepay the correct amount for the gas they will add.

Thus, there is a need for an improved system that provides a vehicle operator with pertinent fuel level and cost information both before fueling and while fueling is in progress. In order to provide one or more benefits described above, example embodiments may include a vehicle having a fuel tank with a fuel gauge. The fuel gauge may consist of two main parts, a sending unit mounted in the fuel tank and a display unit presented on the instrument panel of the vehicle. Example vehicles may provide information to a user based on the fuel gauge, such as via one or more displays viewable from outside the vehicle, particularly near the fuel filler which is often positioned toward the rear of the vehicle. The display(s) may show the number of gallons needed to fill the tank.

In some examples, the vehicle may also determine a cost to fill the tank. This can be determined based on the number of gallons required, multiplied by the cost of gas (determined in one or more ways discussed in further detail below). This cost may also be displayed to the user via the one or more displays.

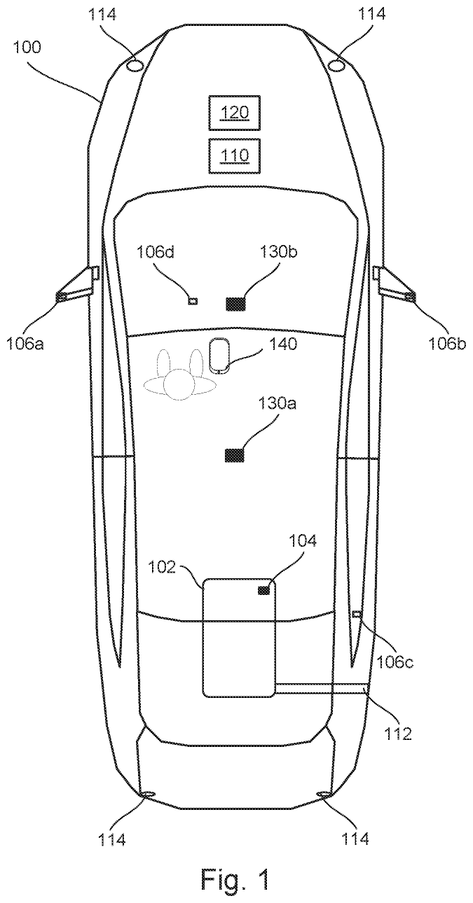

FIG. 1 illustrates an example vehicle 100 according to embodiments of the present disclosure. The vehicle 100 may be a standard gasoline powered vehicle, a hybrid vehicle, an electric vehicle, a fuel cell vehicle, and/or any other mobility implement type of vehicle. The vehicle 100 includes parts related to mobility, such as a powertrain with an engine, a transmission, a suspension, a driveshaft, and/or wheels, etc. The vehicle 100 may be non-autonomous, semi-autonomous (e.g., some routine motive functions controlled by the vehicle 100), or autonomous (e.g., motive functions are controlled by the vehicle 100 without direct driver input).

In the illustrated example, the vehicle 100 includes a fuel tank 102. The fuel tank 102 may be positioned on an underside near the rear of the vehicle 100, as illustrated in FIG. 1. The fuel tank 102 may have a particular capacity, such as 12 or 16 gallons. The fuel tank 102 may include a fuel sensor 104, which may be used to determine the amount of fuel or fuel level of the fuel tank. The fuel sensor 104 or fuel gauge may include a sending unit in the fuel tank 102, as well as an indicator 106d positioned on the instrument panel or dashboard of the vehicle 100.

The fuel tank 102 may also include a shaft connected to the fuel filler 112, as illustrated in FIG. 1. The fuel filler may be a flap or plate positioned to cover the opening to the fuel tank 102. When an operator wants to add fuel to the tank, he or she may open the fuel filler by inserting a nozzle of a gas pump into the shaft. Some vehicle may include a cap that must be unscrewed in order to insert the nozzle. Other vehicle may be cap-less, such that the operator need only insert the nozzle to open the fuel filler. Some vehicle may also include a hinged door that opens to expose the fuel filler. Other vehicle may not include the hinged door.

Vehicle 100 may also include a plurality of external displays 106a-d. Displays 106a and 106b are positioned on the side mirrors of the vehicle 100. Display 106c is positioned on a rear window of the vehicle 100, nearby the fuel filler 112. One or more of these displays is in view of the operator during fueling of the vehicle, even while the vehicle ignition is off. The information displayed on these displays can include a starting fuel level, a current fuel level as fuel is added, a cost to fill the fuel tank 102, and more. In some examples, the vehicle 100 may be connected to a remote computing device 140 (e.g., via the communication system 120), which may act as an additional display for various information such as the starting fuel level, current fuel level, cost, and more.

Vehicle 100 may also include one or more lights 114, such as front head lights, rear lights, flood lamps, and more. One or more of the lights may be controlled by the processor 110 of the vehicle for one or more purposes, such as those discussed in further detail below.

Vehicle 100 may also include one or more cameras 130a-b. Cameras 130a-b may be exterior facing cameras, that are configured to capture images of the surroundings of the vehicle 100. As such, each of the cameras 130a and 130b may be mounted inside or outside the vehicle, may include multiple subassemblies, and/or the processor 110 may be configured to stitch together images from multiple cameras to provide a full image. Camera 130a is illustrated as being mounted to a top of the vehicle 100. Camera 130b is illustrated as being mounted to the backside of a rearview mirror of the vehicle 100. FIG. 1 illustrates two cameras 130a and 130b, however it should be appreciated that more or fewer number of cameras may be used, and that the position of the cameras may be different from that shown in the Figures.

Vehicle 100 may also include a communication system 120. Communication system 120 may be configured to communicate with one or more remote computing devices and/or infrastructure devices. In the illustrated example, the communication system 120 may include a dedicated short-range communication (DSRC) module. A DSRC module includes antenna(s), radio(s) and software to communicate with nearby vehicle(s) via vehicle-to-vehicle (V2V) communication, infrastructure-based module(s) via vehicle-to-infrastructure (V2I) communication, and/more, more generally, nearby communication device(s) (e.g., a mobile device-based module) via vehicle-to-everything (V2X) communication. This can include, in particular, the remote computing device 140. Various information can be transmitted and received by communication system 120, as discussed in further detail below.

Processor 110 may be configured to carry out one or more functions or actions, such as those described herein. In particular, the processor 110 may be configured to determine a fuel level of the fuel tank 102. In some examples, the fuel level may be determined using the fuel gauge 104. The determined fuel level may be a starting fuel level. The starting fuel level may be the fuel level at the point at which the vehicle is turned off, particularly when the vehicle is turned off after the operator has entered or arrived at a gas station. The processor 110 may also determine a current fuel level. The current fuel level may change over time when the vehicle is turned off, as fuel is added to the fuel tank 102 during the filling procedure. The processor may be configured to determine and monitor any changes in the fuel level over time. The current fuel level, and any changes over time when fuel is being added, may be determined based on the fuel sensor 104, based on information received via V2I communication, via information gathered by one or more vehicle cameras, and/or based on other information. In some examples, the starting fuel level may be determined solely based on the fuel sensor 104, and any changes to the fuel level may be determined based on the V2I communication and/or information gathered by the vehicle camera(s).

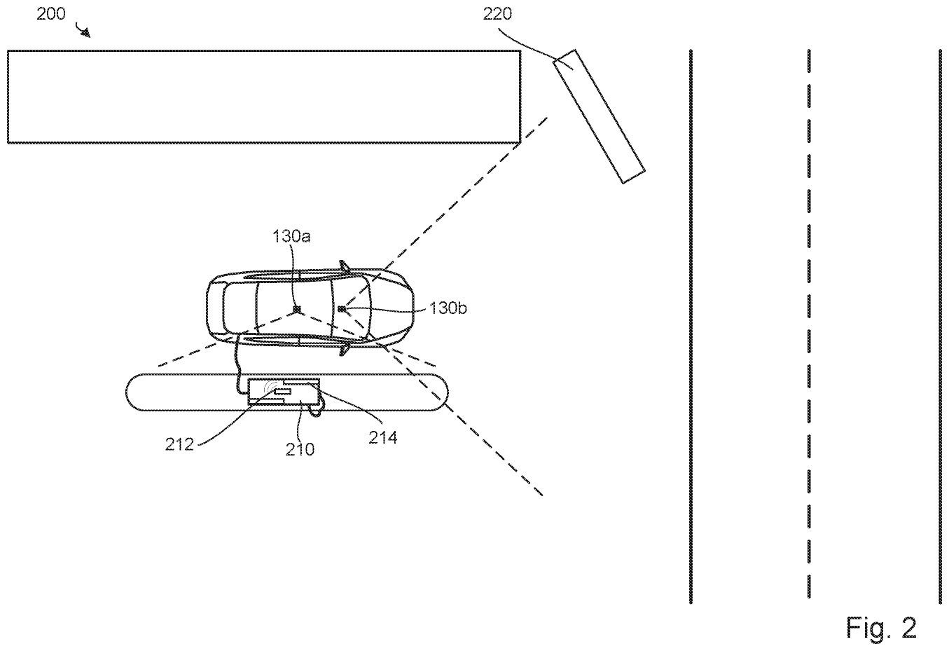

V2I communication may provide the processor 110 with the amount of fuel being added. The fuel pump may have an accurate reading of the flow of gas into the vehicle. The processor may determine the current fuel level based on the starting fuel level determined by the fuel sensor 104, and the added fuel received from the fuel pump via the V2I communication. In some examples, the vehicle 100 may communicate directly with the fuel pump (e.g., via the communication system 212 of the fuel pump 210 in FIG. 2). Alternatively, the vehicle 100 may communicate via V2I communication with a separate computing system associated with pump 210 at the gas station (i.e., a centralized server or other system).

In some examples, the processor 110 may be further configured to determine the current fuel level of the fuel tank based on images captured by the one or more exterior facing cameras 130a and/or 130b. The cameras may be configured to captured images of a display 214 of the fuel pump 210, which may indicate the amount of fuel being added to the fuel tank 102. FIG. 2 illustrates an example in which the camera 130a field of view includes the display 214 of fuel pump 210. As gas is added to the fuel tank 102, the amount added is shown on the display 214. Vehicle 100 may perform image recognition and/or analysis to determine the amount of fuel being added, and the amount added may be used to determine the current fuel level (e.g., by combining the starting fuel level with the amount of fuel added).

In some examples, processor 110 may also be configured to determine a cost to fill the fuel tank 102. This may include first determining the price of gas. Determining the price of gas may be done in one of several ways.

In a first method, the price of gas may be determined based on a vehicle location. The vehicle location may be determined via GPS or any other mechanism. The vehicle location may then be compared to the known locations of gas stations. If the vehicle location is within a threshold distance from a gas station, the processor may determine that the vehicle is present at that gas station. The processor may then determine the cost of gas based on the determined gas station at which the vehicle is located. This can be done via communication with a server or other communication device (e.g., via communication system 120), which may have a stored list of gas stations and/or gas prices at each station. In some examples, this may include communication with the remote computing device 140, which may include one or more applications that provide information about the price of gas at various gas stations, such as Gas Buddy, Gas Guru, Waze, etc. As such, the processor 110 may be configured to determine a geographic location of the vehicle 100, and then based on the geographic location (and the starting fuel level), determine the cost to fill the tank.

A second technique for determining the cost to fill the fuel tank 102 may include using V2I communication. The fuel pump 210 may include a communication system 212 used for V2I communication, and the pump 210 may transmit the price of gas to the vehicle 100. The processor may then take the received pricing information and multiply by the amount of fuel needed to determine the cost to fill the fuel tank 102.

A third technique for determining the cost to fill the fuel tank 102 may include gathering information via the one or more vehicle cameras. FIG. 2 illustrates that camera 130b includes the gas station sign 220 in its field of view. The gas station sign may display the price of gas, which may be therefore captured by the camera 130b. The processor may then perform image recognition/analysis to determine the price of gas, and thereby determine the cost to fill up the fuel tank 102.

In some examples, the operator of the vehicle 100 may specify a type of gas required (e.g., diesel, unleaded, a particular octane preferred, etc.). Then using one or more of the techniques described above, the processor 110 may determine the correct price for the type of gas that the operator intends to add to the fuel tank 102.

The processor 110 may also be configured to display the starting fuel level, the current fuel level, and/or the cost to fill the fuel tank 102 on the one or more external vehicle displays 106a, 106b, and 106c, while the vehicle ignition is turned off. When the vehicle ignition is turned off, the instrument panel (end display 106d) may also be off, preventing the operator from determining the fuel level and cost to fill the fuel tank. The operator may want to see the starting and/or current fuel level and cost to fill the fuel tank while the vehicle is turned off.

In some examples, the processor 110 is further configured to display the starting fuel level, current fuel level, and/or the cost to full the fuel tank on the one or more external displays responsive to determining that (i) the vehicle ignition is turned off and (ii) that a fuel filler 112 of the fuel tank is open. In this manner, the external displays do not always show the fuel level and/or cost, but instead the processor 110 uses the trigger of the vehicle ignition being off plus the fuel filler 112 being open in order to begin displaying various information via the external displays. This can enable the operator positioned outside the vehicle to see how full the fuel tank is, see how much it will cost to fill the fuel tank, and see any updates to these amounts as fuel is added to the fuel tank. Real time updates enables the user to be able to stop filling the fuel tank when he or she chooses, for example when the fuel tank reaches a particular level (e.g., half tank), or when a particular amount of gas is added or money is spent (e.g., three gallons or ten dollars).

The operator can also use the external displays to confirm that the tank is full after the pump automatically shuts off. In some cases high pressure in the fuel tank and/or shafts connected to the fuel filler cause a premature triggering of the pump shutoff mechanism. However, the fuel tank may not actually be full in this instance, causing the driver to inadvertently leave the gas station without a full fuel tank. The operator can double check that the fuel tank is full before he or she leaves the fuel pump by seeing real-time updates to the fuel level displayed outside the vehicle.

In some examples, the processor 110 may receive input from the operator via user interface of the vehicle 100. The input can indicate a target fuel tank input amount. The target fuel tank input amount may be an amount of gallons the operator wishes to add, may be an amount of money the operator wishes to spend, may be a target end fuel amount the operator wishes to fill the tank to, or may be some other metric. The target fuel tank input amount may correspond to a number of gallons of gas, which when combined with the starting fuel level, is less than a full tank. In other words, the user can indicate via a user interface of the vehicle (or via a connected computing device such as remote computing device 140) that he or she intends to fill up the fuel tank to less than a full fuel level or full tank. The user can also indicate that he or she wants the fuel pump to automatically stop fueling when the intended level, added gas, or spent money is reached.

For example, an operator may indicate that he wants to fill a 12 gallon fuel tank up to ¾ full. In this scenario, the target fuel tank input amount is a target end fuel level of ¾ tank or nine gallons. If the starting fuel level is ½ tank or six gallons, then the fuel amount corresponding to the target fuel tank input amount is ¼ tank, or three gallons. The processor 110 may determine and display the cost to add three gallons of gas to the fuel tank. In addition, the processor 110 may monitor the fuel level as gas is added, and when the current fuel level matches the target end fuel level (i.e. ¾ tank, or 9 gallons), the processor 110 may cause one or more action to be taken to stop the fueling process. For example, the processor 110 may transmit a signal to the pump 210 via V2I communication, instructing the fuel pump 210 to shut off. The pump 210 may then automatically shut off. In addition or alternatively, the vehicle 100 may responsively flash one or more lights 114 and/or beep or chirp a vehicle horn responsive to the current fuel level matching a target end fuel level.

In another example, the target fuel tank input amount may be a target amount of money the operator wishes to spend. For instance, the operator may wish to add ten dollars of fuel. The operator may input the ten dollar instruction via a user interface, and the processor 110 may convert the ten dollars into a corresponding amount of gallons. The processor 110 may then monitor the current fuel level as fuel is added, in order to stop when the corresponding amount of gallons is reached. Alternatively, the processor 110 may monitor the amount of money spent as fuel is added to the fuel tank (e.g., via V2I communication and/or cameras 130a and 130b). The processor 110 can then send a signal to the fuel pump 210 to shut off at the appropriate time, flash one or more vehicle lights 114, and/or emit a noise to indicate that the intended amount of money has been spent.

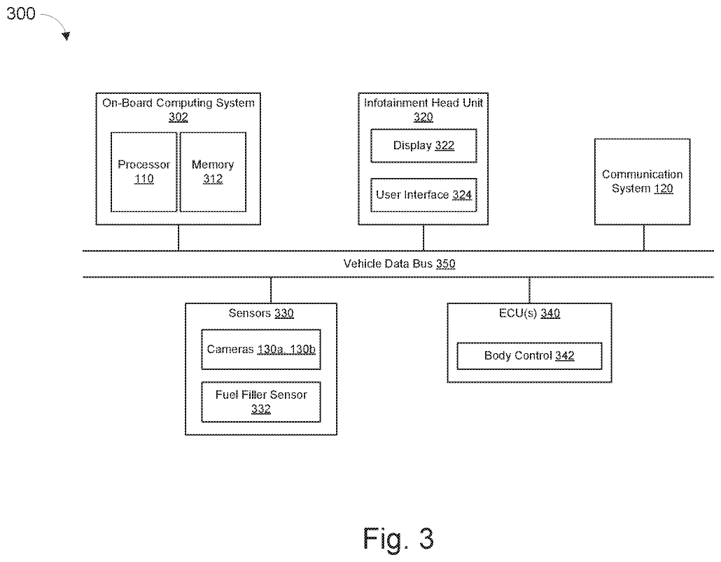

FIG. 3 is an example block diagram of electronic components 300 of the vehicle 100. As illustrated in FIG. 3, the electronic components 300 includes an onboard computing system 302, an infotainment head unit 320, communication system 120, sensors 330, electronic control units (ECUs) 340, and a vehicle data bus 350.

The onboard computing system 302 includes processor 110 (also referred to as a microcontroller unit and a controller) and memory 312. The processor 110 may be any suitable processing device or set of processing devices such as, but not limited to, a microprocessor, a microcontroller-based platform, an integrated circuit, one or more field programmable gate arrays (FPGAs), one or more tensor processing units (TPUs), and/or one or more application-specific integrated circuits (ASICs). The memory 312 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc.). In some examples, the memory 312 includes multiple kinds of memory, particularly volatile memory and non-volatile memory.

The memory 312 is computer readable media on which one or more sets of instructions, such as the software for operating the methods of the present disclosure, can be embedded. The instructions may embody one or more of the methods or logic as described herein. For example, the instructions reside completely, or at least partially, within any one or more of the memory 312, the computer readable medium, and/or within the processor 110 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The infotainment head unit 320 provides an interface between the vehicle 100 and a user or operator. The unit 320 includes digital and/or analog user interfaces 324 (e.g., input devices and output devices) to receive input from and display information for the user(s). The input devices include one or more console input devices, such as a control knob(s), instrument panel(s), digital camera(s) for image capture and/or visual command recognition, touchscreen(s), audio input device(s) (e.g., cabin microphone), button(s), touchpad(s), etc. The output devices include the display 322. Further, the output devices may include instrument cluster outputs (e.g., dials, lighting devices), actuators, speakers, etc.

The communication system 120 includes wired or wireless network interfaces to enable communication with external networks. The communication system 120 also includes hardware (e.g., processors, memory, storage, antenna, etc.) and software to control the wired or wireless network interfaces. In the illustrated example, the communication system 120 includes one or more communication controllers for cellular networks (e.g., Global System for Mobile Communications (GSM), Universal Mobile Telecommunications System (UMTS), Long Term Evolution (LTE), Code Division Multiple Access (CDMA)), Near Field Communication (NFC) and/or other standards-based networks (e.g., WiMAX (IEEE 802.16m), local area wireless network (including IEEE 802.11 a/b/g/n/ac or others), Wireless Gigabit (IEEE 802.11ad), etc.). In some examples, the communication system 120 includes a wired or wireless interface (e.g., an auxiliary port, a Universal Serial Bus (USB) port, a Bluetooth® wireless node, etc.) to communicatively couple with a mobile device (e.g., a smart phone, a wearable, a smart watch, a tablet, etc.). In such examples, the vehicle 100 may communicate with the external network via the coupled mobile device. The external network(s) may be a public network, such as the Internet; a private network, such as an intranet; or combinations thereof, and may utilize a variety of networking protocols now available or later developed including, but not limited to, TCP/IP-based networking protocols.

The sensors 330 are arranged in and/or around the vehicle 100. For example, cameras 130a and 130b may be mounted such that they are exterior facing cameras, configured to capture images in a direction point outward from the vehicle 100. Fuel filler sensor 332 may be mounted proximate the fuel filler 112 in order to determine whether fuel filler is open or closed. Various other sensors may be included as well.

The ECUs 340 monitor and control the subsystems of the vehicle 100. For example, the ECUs 340 are discrete sets of electronics that include their own circuit(s) (e.g., integrated circuits, microprocessors, memory, storage, etc.) and firmware, sensors, actuators, and/or mounting hardware. The ECUs 340 communicate and exchange information via a vehicle data bus (e.g., the vehicle data bus 350). Additionally, the ECUs 340 may communicate properties (e.g., status of the ECUs 340, sensor readings, control state, error and diagnostic codes, etc.) to and/or receive requests from each other. For example, the vehicle 100 may have dozens of the ECUs 340 that are positioned in various locations around the vehicle 100 and are communicatively coupled by the vehicle data bus 350.

In the illustrated example, the ECUs 340 include a body control module 342. The body control module 342 controls one or more subsystems throughout the vehicle 100, such as power windows, power locks, an immobilizer system, power mirrors, etc. For example, the body control module 342 includes circuits that drive one or more of relays (e.g., to control wiper fluid, etc.), brushed direct current (DC) motors (e.g., to control power seats, power locks, power windows, wipers, etc.), stepper motors, LEDs, etc.

The vehicle data bus 350 communicatively couples the on-board computing system 302, the infotainment head unit 320, the communication system 120, the sensors 330, and the ECU(s) 340. In some examples, the vehicle data bus 350 includes one or more data buses. The vehicle data bus 350 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

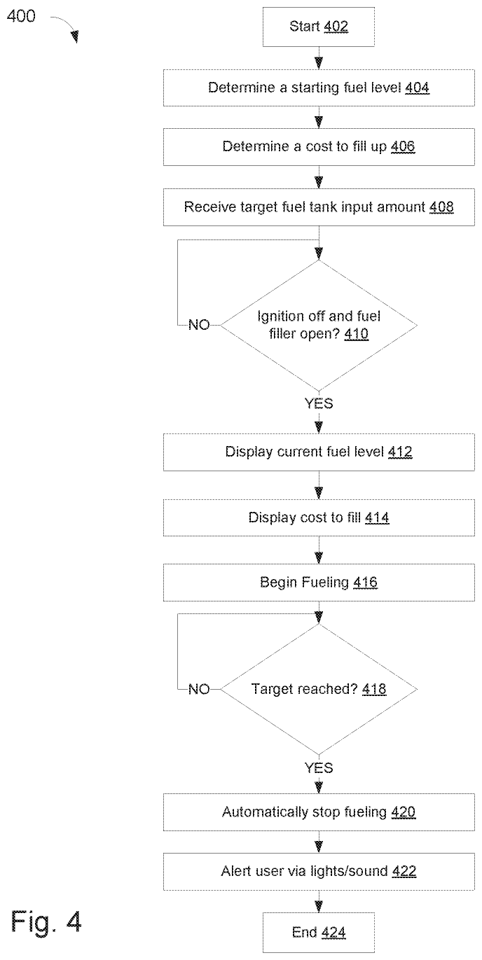

FIG. 4 illustrates a flow chart of an example method 400 to determine and display the fuel level and cost to fill the fuel tank. The flowchart of FIG. 4 is representative of machine readable instructions that are stored in memory (such as the memory 312 of FIG. 3) and include one or more programs which, when executed by a processor (such as the processor 110), cause the vehicle 100 to implement the example the functions and actions described herein. While the example program is described with reference to the flowchart illustrated FIG. 4, many other methods of implementing the example functions and actions described herein may alternatively be used. For example, the order of execution of the blocks may be rearranged, changed, eliminated, and/or combined to perform the method 400. Further, because the method 400 is disclosed in connection with the components of FIGS. 1-3, some functions of those components will not be described in detail below.

Method 400 may start at block 402. At block 404, method 400 may include determining a starting fuel level. The starting fuel level may be the amount of fuel in the fuel tank when the vehicle arrives at a gas station and turns off the vehicle.

Method 400 may then include determining a cost to fill the fuel tank. This can be determined in several ways, as described above. For example, the vehicle geographic location may be determined, and compared to the location of various gas stations. The particular gas station at which the vehicle is located may be determined, and the price of gas may be determined based on the gas station. This can include using information received from one or more sources such as a connected remote computing device (e.g., smartphone) running an application such as Gas Buddy, Gas Guru, and other applications that indicate the cost of gas at various gas stations. Alternatively or in addition, the price of gas may be determined based on V2I communication with the gas station, and/or via images of a sign present outside the gas station within view of the vehicle camera.

At block 408, method 400 may include receiving a target fuel tank input amount. As noted above, the target fuel tank input amount may be in gallons to be added, money to be spent, a target end fuel level, or more. This target may be input by an operator via a user interface of the vehicle, or via a connected computing device, such as remote computing device 140.

At block 410, method 400 may include determining whether the vehicle ignition has been turned off, and whether the fuel filler has been opened. This indicates that the operator is outside the vehicle and has opened the fuel filler. If the ignition has been turned off and the fuel filler is open, method 400 may proceed to block 412.

At block 412, method 400 may include displaying the current fuel level. Block 414 may include displaying the cost to fill the fuel tank. Either or both of the current fuel level and the cost to fill the fuel tank may be displayed on the one or more external displays of the vehicle. Fueling may then begin at block 416.

At block 418, method 400 may include determining whether the target fuel tank input amount has been reached. This can include determining whether the target number of gallons have been added, whether the fuel tank has reach a target end fuel level, whether the target amount of money has been spent, and more.

If the target has been reached, method 400 may include automatically stopping fueling at block 420. This may be done by transmitting an instruction or indication to the fuel pump (e.g., via V2I communication), causing the fuel pump to shut off.

In addition or alternatively, method 400 may include alerting the operator that the target has been reached by flashing the vehicle lights, by sounding an alert, or by taking some other action at block 422. This can alert the operator that the level has been reached, enabling the operator to manually stop the fueling operation. Method 400 may then end at block 424.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively. Additionally, as used herein, the terms “module” and “unit” refer to hardware with circuitry to provide communication, control and/or monitoring capabilities. A “module” and a “unit” may also include firmware that executes on the circuitry.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle comprising:
a fuel tank including a fuel sensor;
one or more external vehicle displays; and
a processor configured to:
determine a current fuel level of the fuel tank;
determine a cost to fill the fuel tank; and
display the current fuel level and the cost to fill the fuel tank on the one or more external vehicle displays, while a vehicle ignition is turned off.

2. The vehicle of claim 1, wherein the processor is further configured to display the current fuel level and the cost to full the fuel tank on the one or more external displays responsive to determining that (i) the vehicle ignition is turned off and (ii) that a fuel filler of the fuel tank is open.

3. The vehicle of claim 1, wherein the processor is further configured to:
receive a target fuel tank input amount, wherein combination of (i) a fuel amount corresponding to the target fuel tank input amount and (ii) a starting fuel level is less than a full fuel level;
determine a target end fuel level based on the target fuel tank input amount; and
automatically stop an in-progress fueling operation responsive to determining that the current fuel level matches the target end fuel level.

4. The vehicle of claim 3, wherein the target fuel tank input amount comprises one or more of a target amount of money, a target quantity of fuel to add, and the target end fuel level.

5. The vehicle of claim 3, wherein the processor is further configured to (i) flash one or more vehicle lights or (ii) emit a sound using a vehicle horn responsive to determining that the current fuel level matches the target end fuel level.

6. The vehicle of claim 1, wherein the vehicle further comprises a communication system configured for vehicle to infrastructure (V2I) communication, and wherein the processor is further configured to determine the current fuel level of the fuel tank based on fueling data received via V2I communication.

7. The vehicle of claim 1, wherein the vehicle further comprises one or more exterior facing cameras, and wherein the processor is further configured to determine the current fuel level of the fuel tank based on images captured by the one or more exterior facing cameras.

8. The vehicle of claim 1, wherein the processor is further configured to:
determine a geographic location of the vehicle; and
determine the cost to fill the fuel tank based on the geographic location.

9. The vehicle of claim 1, wherein the vehicle further comprises a communication system configured for vehicle to infrastructure (V2I) communication, and wherein the processor is further configured to determine the cost to fill the fuel tank based on price data received via V2I communication.

10. The vehicle of claim 1, wherein the vehicle further comprises one or more exterior facing cameras, and wherein the processor is further configured to determine the cost to fill the fuel tank based on images captured by the one or more exterior facing cameras.

11. The vehicle of claim 1, wherein the vehicle further comprises a communication system configured for communication with a remote computing device, and wherein the processor is further configured to determine the cost to fill the fuel tank based on price data received from the remote computing device.

12. The vehicle of claim 1, wherein the processor is further configured to transmit the current fuel level and the cost to fill the fuel tank to a remote computing device.

13. A method comprising:
determining a current fuel level of a fuel tank of a vehicle, the fuel tank including a fuel sensor;
determining a cost to fill the fuel tank; and
displaying the current fuel level and the cost to fill the fuel tank on one or more external vehicle displays, while a vehicle ignition of the vehicle is turned off.

14. The method of claim 13, further comprising displaying the current fuel level and the cost to full the fuel tank on the one or more external displays responsive to determining that (i) the vehicle ignition is turned off and (ii) that a fuel filler of the fuel tank is open.

15. The vehicle of claim 13, further comprising determining the current fuel level of the fuel tank based on fueling data received via vehicle to infrastructure (V2I) by a communication system of the vehicle configured for V2I communication.

16. The method of claim 13, further comprising determining the current fuel level of the fuel tank based on images captured by one or more exterior facing cameras of the vehicle.

17. The method of claim 13, further comprising:
determining a geographic location of the vehicle; and
determining the cost to fill the fuel tank based on the geographic location.

18. The method of claim 13, further comprising determining the cost to fill the fuel tank based on price data received via vehicle to infrastructure (V2I) communication by a communication system of the vehicle configured for V2I communication.

19. The method of claim 13, further comprising determining the cost to fill the fuel tank based on images captured by one or more exterior facing cameras of the vehicle.
